(19) United States
(12) Patent Application Publication
(10) Pub. No.: US 2009/0012830 A1
(43) Pub. Date: Jan. 8, 2009

(54) APPARATUS, METHOD, AND PROGRAM FOR EXTRACTING WORK ITEM

(75) Inventors: Takeshi Yokota, Hitachi (JP); Kaoru Kawabata, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/165,698

(22) Filed: Jul. 1, 2008

(30) Foreign Application Priority Data
Jul. 5, 2007 (JP) 2007-176847

(51) Int. Cl. G06Q 10/00

(52) U.S. Cl. 705/7

(57) ABSTRACT

A work item extraction apparatus includes: a checklist DB; a checklist input unit for receiving input information to the checklist of the list DB; a work item DB; a work item extraction rule DB; a work item extraction unit for determining whether or not input information of the checklist input unit satisfies an extraction condition of each checklist corresponding to a predetermined work item, for calculating an evaluation value based on a ratio between a total number of the checklist corresponding to the predetermined work item and a relevant number of the checklist satisfying the extraction condition, and for extracting the predetermined work item when the value exceeds a predetermined threshold; and a work-item-extraction-result display unit for outputting the work item extracted by the work item extraction unit to a display screen.

### BACKGROUND OF THE INVENTION

1. Field of the Invention

The present invention relates to an apparatus, a method, and a program for extracting a work item(hereinafter referred to as “work item extraction apparatus,” “work item extraction method,” and “work item extraction program” as needed).

2. Description of the Related Art

When a project is shifted from a plan to a practice, it is requested to clarify an item to be carried out in the project. Conventionally, as a technology for extracting a work item to be carried out in a project, a technology described in Japanese Patent Laid-Open Publication No. 2003-296528 is cited. In this technology is performed a process of extracting work items, whose risk rates exceed an allowable risk rate, from work items to be carried out in the project and taking the extracted work items in a project management process.

In order to enhance the success probability of a project, it is important to properly define a work item to be carried out at the start of the project. In addition, the work item is defined from various points of view such as the purpose, work item, promotion organization, and risk of the project. In addition, generally, if there are many work items, it is possible to meet various needs; however, on the contrary, it takes more human and equipment cost to carry out the work.

In a conventional technology such as the Japanese Patent Laid-Open Publication No. 2003-296528, it is assumed that the work items to be carried out in the project are input information already given, and means for efficiently inputting the input information is neither described nor suggested. Accordingly, because a user determines whether or not to carry out the work directly one by one by manual work from the candidates of enormous number of work items (for example, several thousand items), it is not possible to efficiently extract the work items to be carried out in the project, and there exists a fear of a determination mistake occurring due to the manual work.

Consequently, there is a need for solving the problems and properly extracting a work item to be carried out in a project.

### SUMMARY OF THE INVENTION

In order to solve the problems, an apparatus for extracting a work item according to the present invention comprises: a checklist DB (Data Base) configured to record a checklist that specifies each form of a question and an answer thereto for evaluating a project; a checklist input unit configured to receive input information to the checklist of the checklist DB; a work item DB configured to record a candidate group of the work item extracted to be carried out in the project; a work item extraction rule DB configured to record the work item, the checklist, and a work item extraction rule that associates an extraction condition with the checklist; a work item extraction unit, with respect to all the work item of the work item extraction rule DB, configured to determine whether or not the input information of the checklist input unit satisfies an extraction condition of each the checklist corresponding to a predetermined work item, to calculate an evaluation value based on a ratio between a total number of the checklist corresponding to the predetermined work item and a number of the checklist satisfying the extraction condition, and to extract the predetermined work item when the evaluation value exceeds a predetermined threshold; and a work-item-extraction-result display unit configured to output the work item extracted by the work item extraction unit to a display screen. Other aspects of the work item extraction apparatus and aspects of the work item extraction method and program will be described later.

According to the present invention, it is possible to properly and efficiently extract a work item to be carried out in a project.

### BRIEF DESCRIPTION OF THE DRAWINGS

FIG. 1 is a configuration drawing showing a work item extraction apparatus for extracting a work item to be carried out in a project according to an embodiment of the present invention.

FIG. 2 is a configuration drawing showing an example of checklists of a checklist DB according to the embodiment.

FIG. 3 is a screen drawing showing an example of an input screen of a checklist in a checklist input unit according to the embodiment.

FIGS. 4A and 4B are illustration drawings showing an example of work items of a work item DB according to the embodiment.

FIG. 5 is a configuration drawing showing rules recorded in a work item extraction rule DB according to the embodiment.

FIG. 6 is a screen drawing showing an edit screen displayed by a corresponding relationship display unit for editing the rules recorded in the work item extraction rule DB according to the embodiment.

FIG. 7A is an illustration drawing showing an example of project-work-item data according to the embodiment; FIG. 7B is a display screen showing an example of a work-item-extraction-result according to the embodiment.

FIGS. 8A and 8B are display screens showing examples of the work-item-extraction-result according to the embodiment.

FIG. 9 is a flowchart showing a whole process of the work item extraction apparatus according to the embodiment.

FIG. 10 is a flowchart showing a process of a corresponding relationship definition unit defining the work item extraction rule DB according to the embodiment.

FIG. 11 is a flowchart showing a process of a work item extraction unit extracting a work item to be carried out in a project according to the embodiment.

### BEST MODE(S) FOR CARRYING OUT THE INVENTION

Here will be described an embodiment of the present invention in detail with reference to drawings.

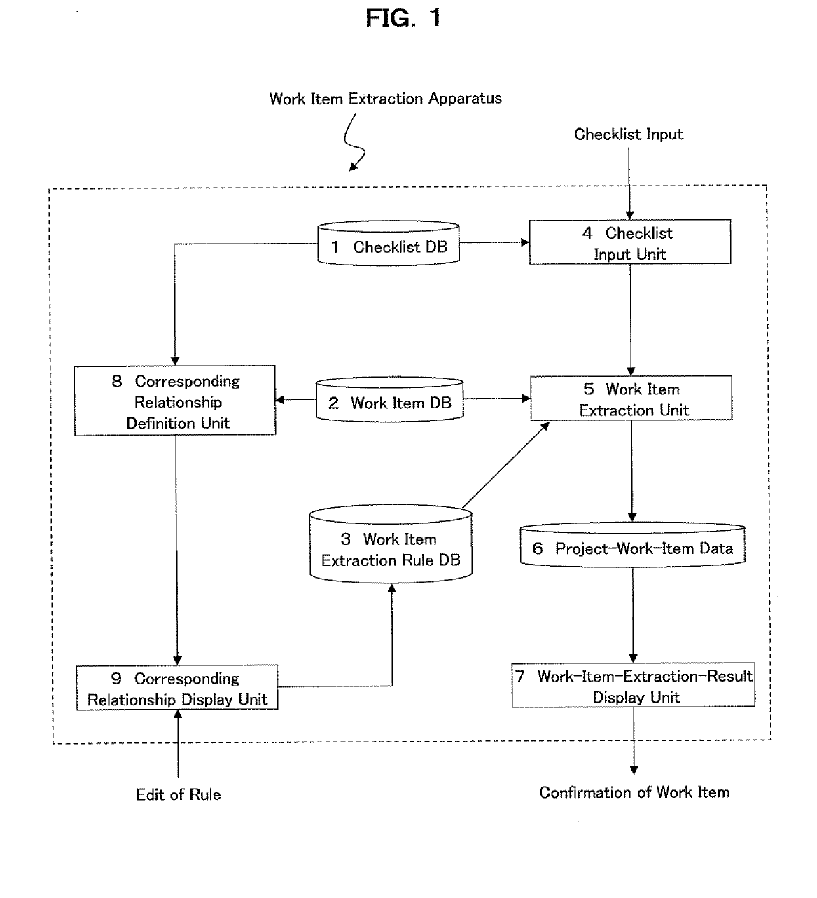

As shown in FIG. 1, a work item extraction apparatus comprises a checklist DB (Data Base) 1, a work item DB 2, a work item extraction rule DB 3, a checklist input unit 4, a work item extraction unit 5, project-work-item data 6, a work-item-extraction-result display unit 7, a corresponding relationship definition unit 8, and a corresponding relationship display unit 9.

In addition, the work item extraction apparatus is configured as a computer comprising at least a memory as a memory means used in executing a calculation process, and a processor for executing the calculation process. In addition, the memory is configured with a RAM (Random Access Memory) and the like. The calculation process is achieved by the processor configured with a CPU (Central Processing Unit) for executing a program on the memory. The embodiment includes, in addition to an operation device, a program for making the operation device execute the calculation process, and a recording medium, where the program is recorded, readable by a computer.

In the checklist DB 1 are recorded checklists by which a risk, merit, and validity of the project are evaluated. In the work item DB 2 are recorded all candidate groups of work items to be normally carried out in the project. In the work item extraction rule DB 3 are recorded the checklists of the checklist DB 1 and work item extraction rules (hereinafter simply referred to as “rules”) made on the basis of associated information between the checklists of the checklist DB 1 and the work items of the work item DB 2.

The checklist input unit 4 presents the checklists of the checklist DB 1 to a user and receives an input with respect to the checklists. The work item extraction unit 5 checks the rules of the work item extraction rule DB 3 and an input result of the checklists received by the checklist input unit 4, and thereby, selects and extracts a work item satisfying the rule from all the work items stored in the work item DB 2. The project-work-item data 6 is data where the work item extracted by the work item extraction unit 5 is recorded. The work-item-extraction-result display unit 7 displays the project-work-item data 6 to a user.

The corresponding relationship definition unit 8 evaluates a similarity degree between a checklist of the checklist DB 1 and a work item of the work item DB 2, and associates the checklist with the work item both having the similarity degree equal to or more than a predetermined threshold. In addition, with respect to a calculation method of the similarity degree between texts, it is possible out of a known similar text search technology to use an arbitrary method, for example, such as a calculation based on a commonness degree of an appearance frequency of a keyword included in the texts.

The corresponding relationship display unit 9 displays the associated information between the checklist and the work item associated by the corresponding relationship definition unit 8 to a user, makes her/him modify the information, and thereby, maintains the rules of the work item extraction rule DB 3.

Here will be described the work item extraction apparatus in detail, using a specific example.

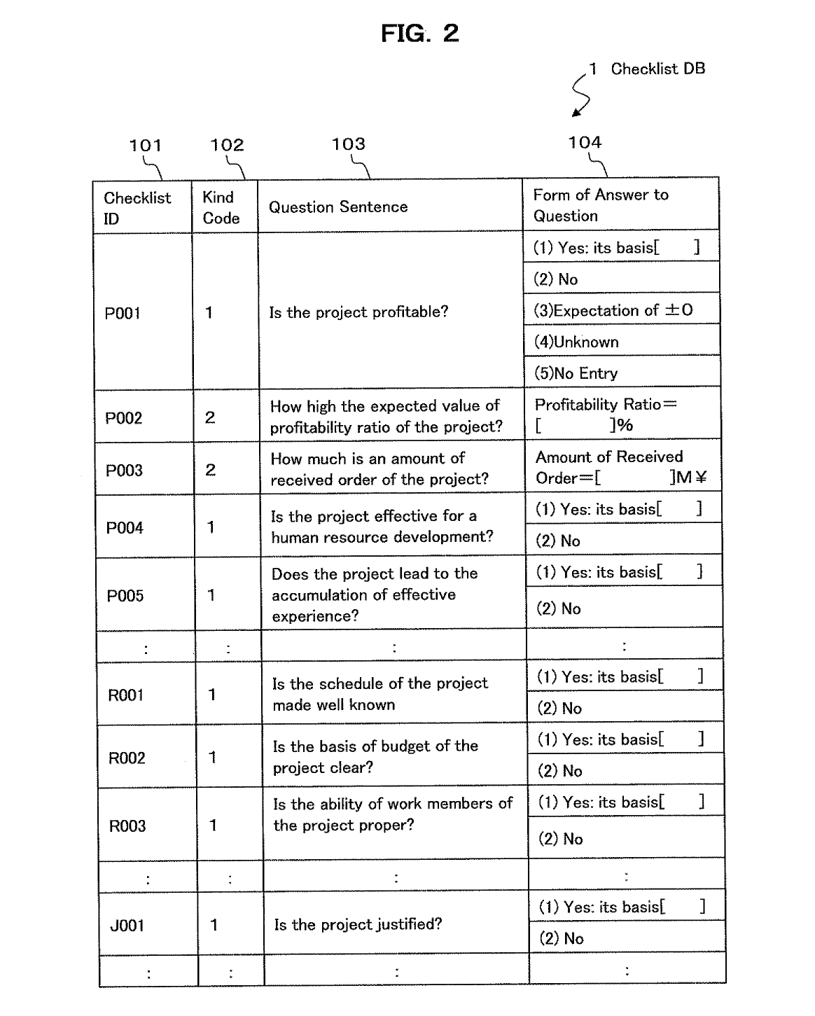

FIG. 2 is a configuration drawing showing an example of the checklists of the checklist DB 1. The checklist is composed of a checklist ID 101, a kind code 102, a question sentence 103, and a form 104 of an answer to the question by associating them.

The checklist ID 101 is an ID (Identification) for identifying the kind of a checklist, and the first character of the ID defines whether the checklist relates to a risk, a merit, or the like. For example, in a case of a checklist with respect to a risk, “R” is set as an initial; in a case of a checklist with respect to a merit, “P” is set as an initial; and in a case of a checklist with respect to a validity, “J” is set as an initial. For example, by searching and focusing a checklist whose initial is “R,” the checklist with respect to the risk is produced. In addition, according to the kind of the checklist, it is possible to define arbitrary information with respect to the project, and for example, the purpose, promotion organization, and the like of the project are cited.

The kind code 102 is data for defining an input pattern of a checklist; if the checklist is an answer selection type, “1” is set, and if it is a text input type, “2” is set. The question sentence 103 and the form 104 of an answer to the question indicate the content of the checklist, and a user inputs the form 104 corresponding to the sentence 103. The form 104 of an answer to the question is an input format (a text is input in [ ]) in inputting the text when the kind code 102 is the text input type; the form 104 is a displayed option list when the code 102 is the answer selection type.

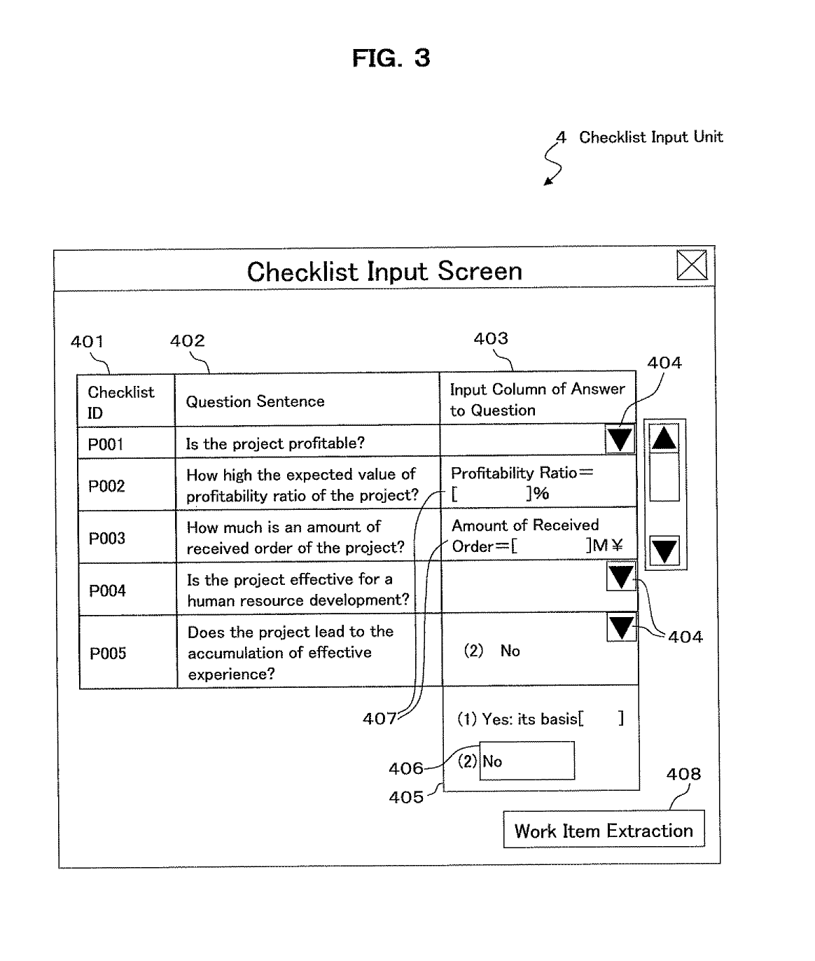

FIG. 3 is a screen drawing showing an example of an input screen of checklists in the checklist input unit 4. The input screen of the checklists has a checklist ID 401, a question sentence 402, and an input-column-of-answer to question 403. When a “x” icon on the upper right side of the input screen is clicked, the screen is closed. In the checklist ID 401 is displayed data read from the checklist ID 101. In the question sentence 402 is displayed data read from the question sentence 103.

The input-column-of-answer to question 403 decides a screen component for inputting data in the form 104 of an answer to the question by the input type according to the kind code 102. For example, when the kind code 102 is the answer selection type, a pull down list 404 is displayed in the input-column-of-answer to question 403, and when a user select the list 404, a list of an answer option registered in the form 104 of an answer to the question is displayed in a pull down display 405. By selecting a pull down selection list 406 from the pull down display 405, the user inputs an answer to the checklist.

On the other hand, when the kind code 102 is the text input type, an answer sentence including an answer space column (shown by [])registered in the form 104 of an answer to the question is displayed in a text box 407. The user inputs a text in the answer space column of the text box 407 and pushes a return key, and thereby, she/he inputs an answer to the checklist. After the input of the checklist is thoroughly performed, the process proceeds to that of the work item extraction unit 5 by clicking a work item extraction button 408.

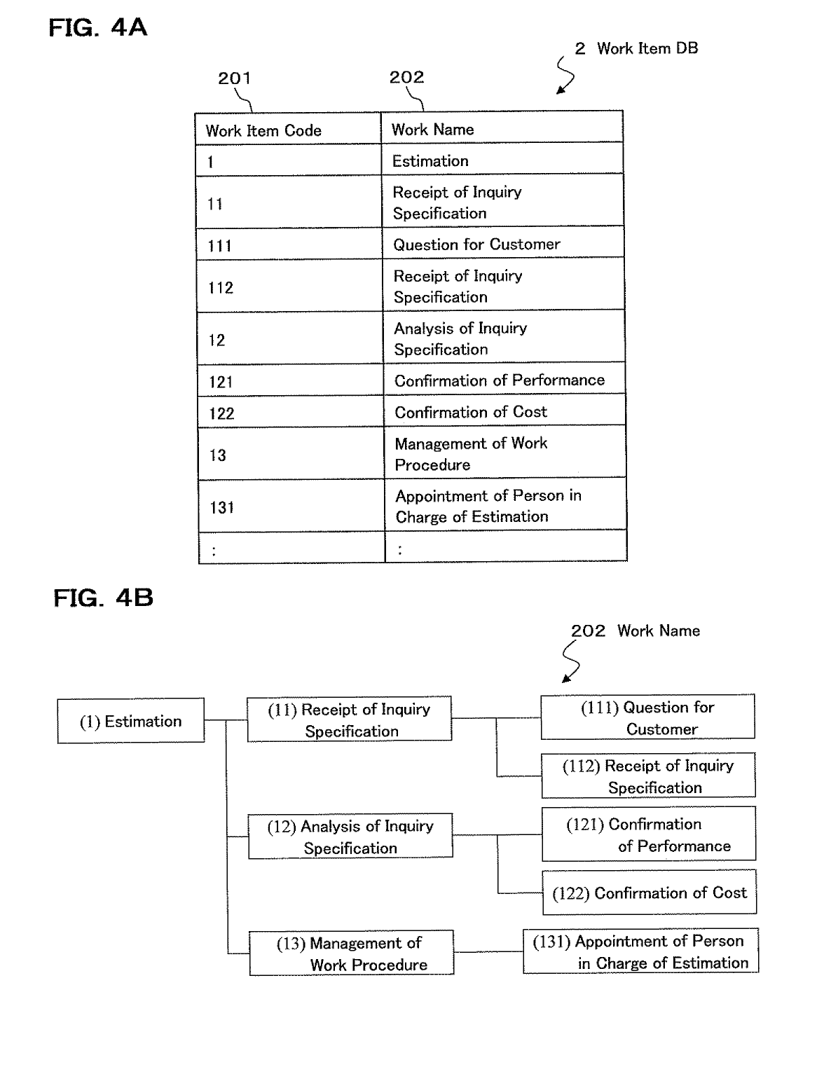

FIGS. 4A and 4B are illustration drawings showing an example of work items of the work item DB 2; FIG. 4A shows the work items composed of a work item code 201 uniquely defining the work items, and a work item name 202 indicating the contents of the work items; and FIG. 4B shows a hierarchical structure of the work item code 201.

Each figure of the work item code 201 corresponds to a hierarchy level of the work item. For example, the first figure is a hierarchy level “1,” the second figure is a hierarchy level “2,” and the third figure is a hierarchy level “3.”

In the work item code 201 a plurality of work items whose upper hierarchy level is common are grouped as work of the upper hierarchy level. For example, a work item “111: Question for Customer” and a work item “112: Inquiry Specification Receipt” are the hierarchy level “3,” and have “11” of the work item 201 is common. Accordingly, the two work items of the hierarchy level “3” are grouped into a work item “11: Inquiry Specification Receipt” corresponding to the upper hierarchy level “2.”

In other words, in order to carry out the work item “11: Inquiry Specification Receipt,” it is requested to carry out the work item “111: Question for Customer” and the work item “112: Inquiry Specification Receipt.” Showing another example, in order to carry out a work item “1: Estimation,” it is requested to carry out the work item “11: Inquiry Specification Receipt” and a work item “Inquiry Specification Analysis.”

In addition, the hierarchical structure of the work item code 201 is used for tracing another work item requested when an extracted work item is carried out. For example, when the extracted work item is a work item having a lower hierarchical work item (parent-child relationship), the lower hierarchical work item is completely extracted as a work item to be carried out in the project. On the other hand, when it is possible from an upper hierarchy of an extracted work item to trace another lower hierarchy different from a lower hierarchy of the extracted work item (sibling relationship), the another lower hierarchy is carried out before the extracted work item; when the extracted work item requests a carried out result of the another lower hierarchy, the another lower hierarchy is extracted together. Thus, not only the extracted work item but also another work item for carrying out the former are extracted together, it is possible to prevent the work from being missed.

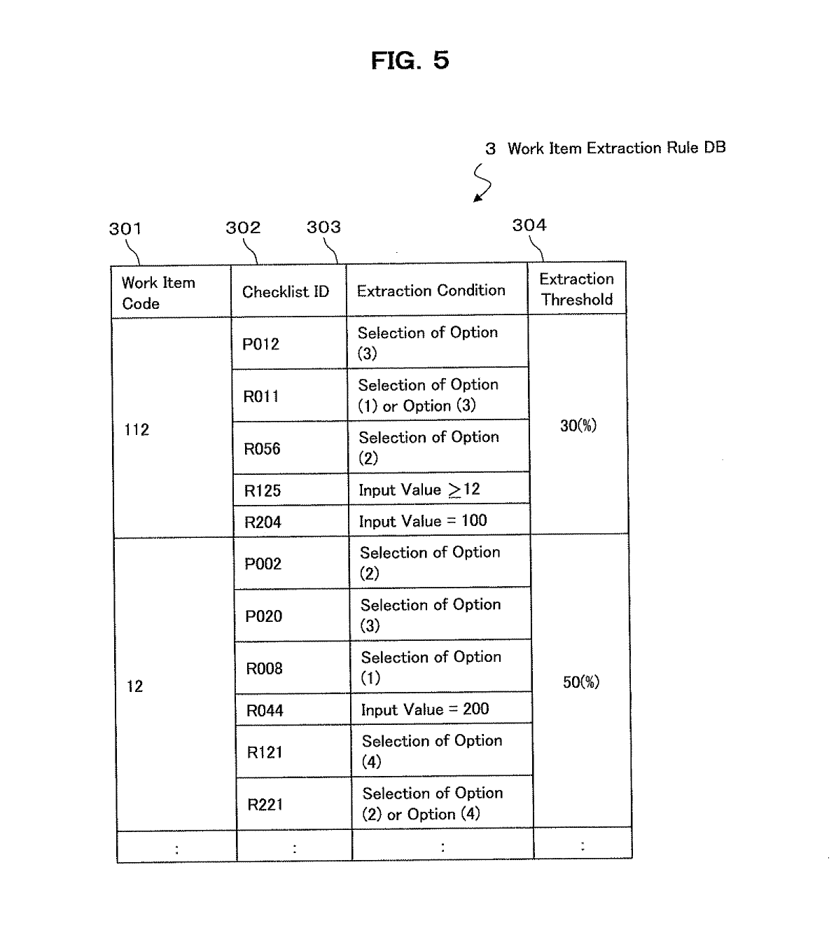

FIG. 5 is a configuration drawing showing rules recorded in the work item extraction rule DB 3.

The work item extraction rule DB 3 is composed of a work item code 301 indicating a work item of an extraction candidate, a checklist ID 302 indicating checklists related to the work item indicated in the code 301, an extraction condition 303 checked with an input result of the checklists indicated in the ID 302, and an extraction threshold 304 compared to a ratio of numbers satisfying the condition 303 by associating the code 301, the ID 302, the condition 303, and the threshold 304.

The extraction condition 303 is checked with the input result of the checklists indicated in the checklist ID 302. The extraction condition 303 is stored, for example, in a form easily executed by the computer.

For example, a conditional expression “input value=100 (if an input value is equal to 100, the condition is satisfied)” is expressed by a combination of an operator “=” for comparing whether or not the left side value and the right side value are equal, and “100” that is the comparison object of the right side value. Consequently, using the right side value and an operator ID (“2” representing≧, “3” representing=, and the like) for specifying an operator, the conditional expression “input value=100” is expressed as “100, 2.”

Furthermore, a conditional expression “when an option ‘1’ or an option ‘3’ is selected, the condition is satisfied” is expressed by a combination of each ID of the options and “or” representing an OR condition. Consequently, using each ID of the options and a logic condition (“1” representing an AND condition, “2” representing an OR condition, and the like), the conditional expression “an option ‘1’ or an option ‘3’ is selected” is expressed as “1, 3, 2.”

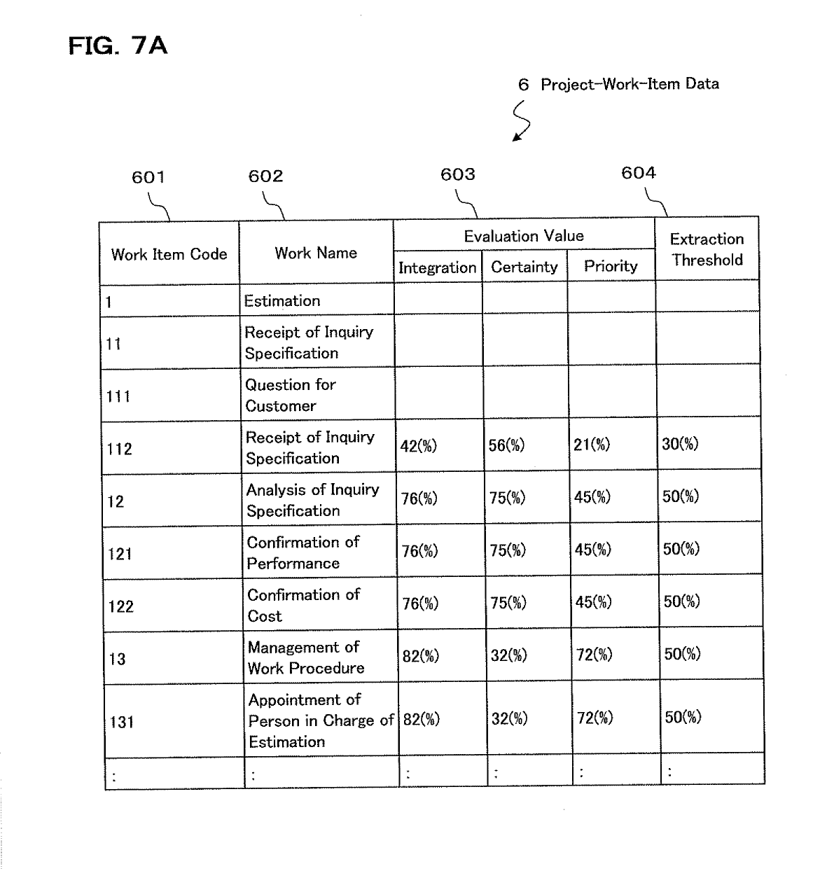

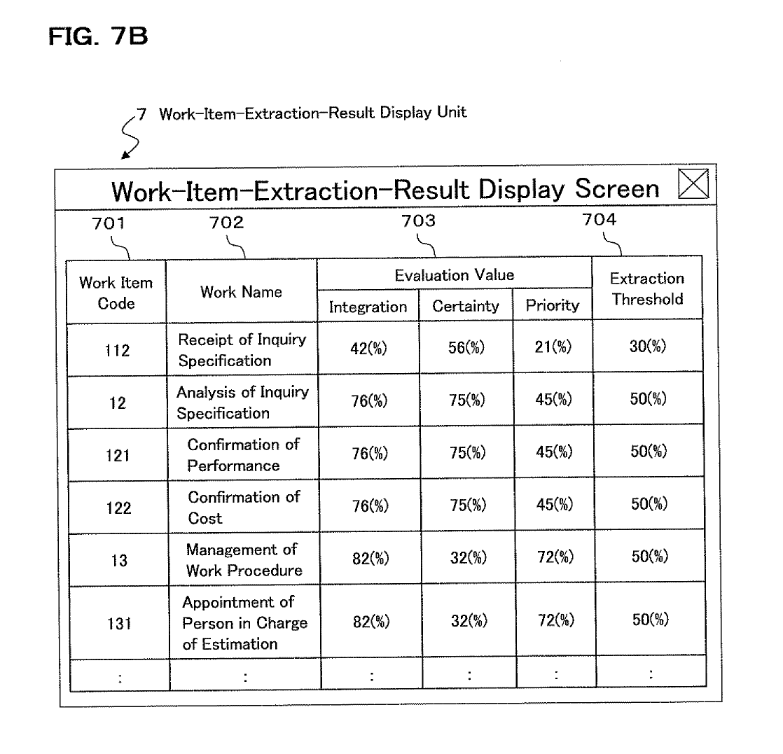

The input item of the checklists indicated in the checklist ID 302 is determined whether or not to satisfy the extraction condition 303 associated with each work item indicated in the work item code 301, and as a result thereof, the extraction threshold 304 is compared to a number of conditions in the extraction condition 303. For example, there exist five conditions in the extraction condition 303 associated with “112” of the work item code 301. When two conditions in the extraction condition 303 are satisfied out of the five, an evaluation value 603 is 2/5=40% (see FIGS. 7A and 7B described later). Accordingly, because of 40%>30% of the extraction threshold 304, a work item indicated as “112” in the work item code 301 is extracted.

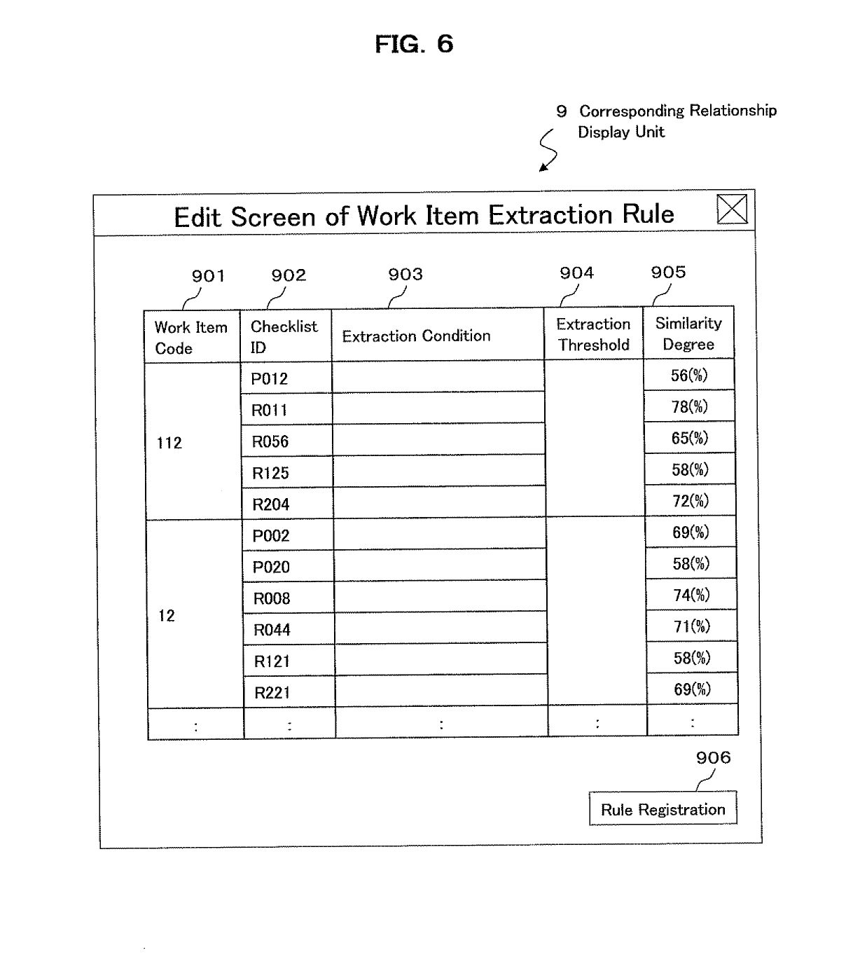

FIG. 6 is a screen drawing showing an example of an edit screen displayed by a corresponding relationship display unit 9 for editing the rules recorded in the work item extraction rule DB 3. The edit screen displays a work item code 901 indicating the work item code 301, a checklist ID 902 indicating the checklist ID 302, an extraction condition 903 indicating the extraction condition 303, an extraction threshold 904 indicating the extraction threshold 304, and a similarity degree 905 between work items indicated in the code 901 and checklists indicated in the ID 902.

Each checklist indicated in the checklist ID 902 has been selected from all the checklists stored in the checklist DB 1. The selection of the checklist may be directly designated one by one from all the checklists by a user, or a checklist whose similarity degree 905 is equal to or more than a predetermined threshold may be automatically designated. A user can edit values displayed in the extraction condition 304 and the extraction threshold 904, and also edit an increase and decrease of the checklists indicated in the checklist ID 902. When a rule registration button 906 is clicked, a rule edited in the edit screen is recorded in the work item extraction rule DB 3.

FIG. 7A is an illustration drawing showing an example of project-work-item data 6. The project-work-item data 6 indicating extracted work items is composed of a work item code 601, a work name 602, an evaluation value 603 indicating a ratio satisfying the extraction condition 303, and an extraction threshold 604 compared to the evaluation value 603 by associating the code 601, the name 602, the value 603, and the threshold 604.

The evaluation value 603 is called by various names according to a kind of a checklist of the checklist ID 302 corresponding to the extraction condition 303 used in a calculation. An “integration” of the evaluation value 603 is a value in a case of a kind of a checklist being not limited. A “priority” of the evaluation value 603 is a value in a case of a kind of a checklist being limited to “Merit.” A “certainty” of the evaluation value 603 is a value in a case of a kind of a checklist is limited to “Risk.”

FIG. 7B shows an example of a display screen indicating extracted work items displayed by the work-item-extraction-result display unit 7. In the display screen are respectively displayed a work item code 701 by reading the work item code 601; a work name 702 by reading the work name 602; an evaluation value 703 by reading the evaluation value 603; and an extraction threshold 704 by reading the extraction threshold 604.

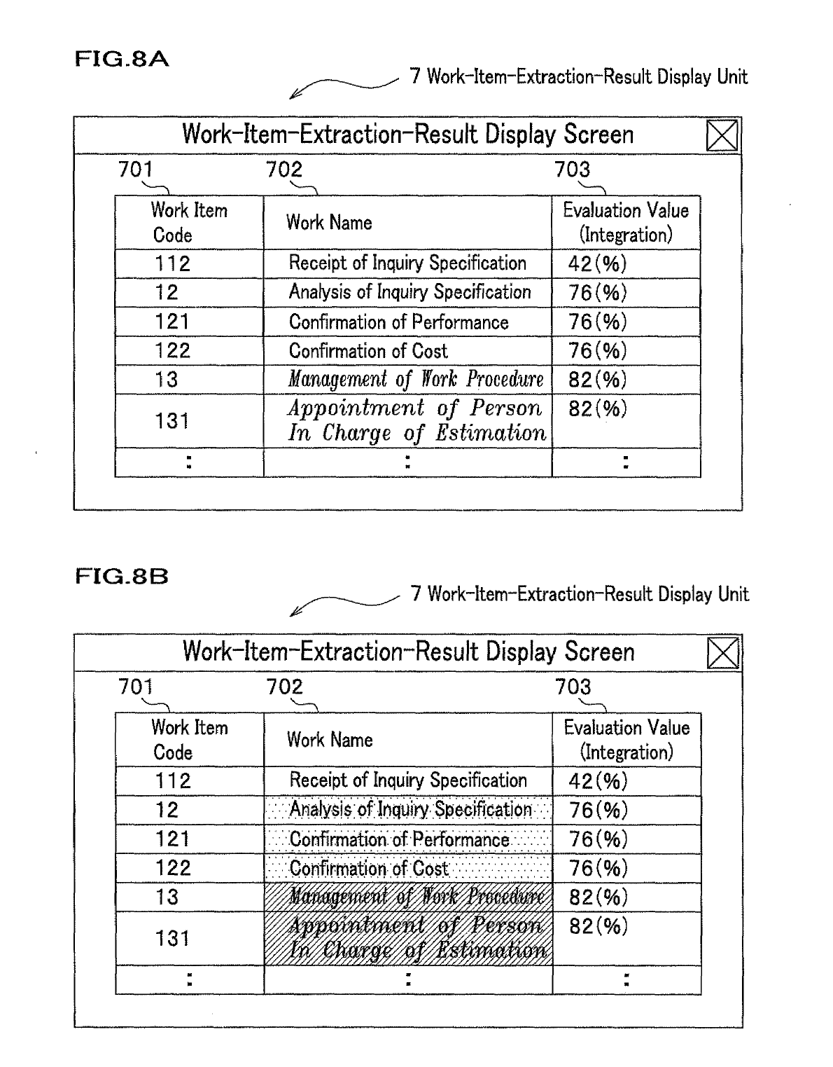

In FIG. 8A a display color of the work name 702 is changed, depending on the evaluation value 703. In FIG. 8B a display pattern of the work name 702 is changed, depending on the evaluation value 703.

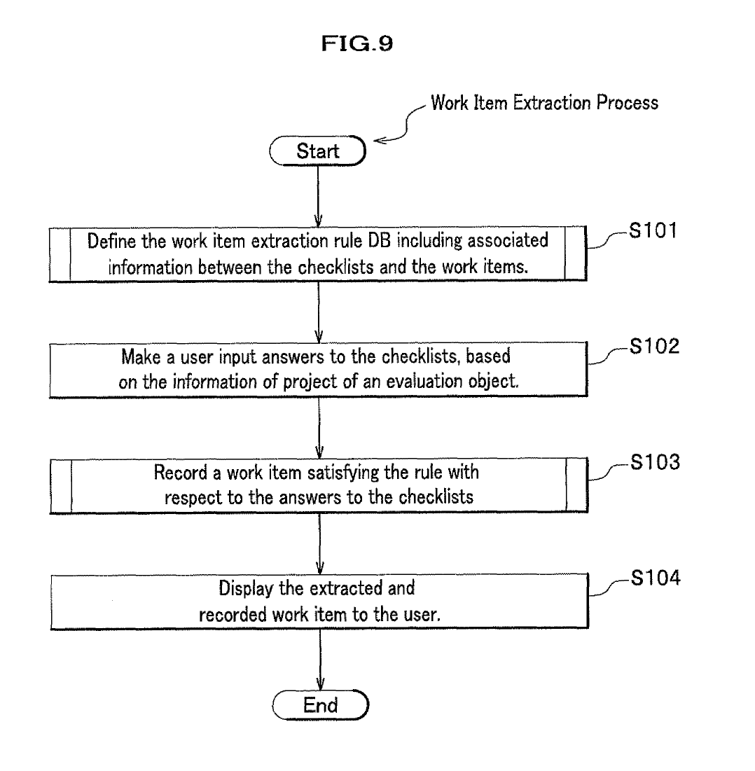

FIG. 9 is a flowchart showing a whole process of the work item extraction apparatus.

The corresponding relationship definition unit 8 defines, via the display screen of the corresponding relationship display unit 9, the work item extraction rule DB 3 including associated information between the checklists of the checklist DB 1 and the work items of the work item DB 2 (S101). The checklist input unit 4 makes a user input answers to the checklists of the checklist DB 1, based on the information of the project of an evaluation object (S102). The work item extraction unit 5 determines the rules recorded in the work item extraction rule DB 3 with respect to the answers to the checklists of the checklist DB 1, and records a work item satisfying the rule in the project-work-item data 6 (S103). The work-item-extraction-result display unit 7 displays the extracted work item recorded in the project-work-item data 6 to the user (S104).

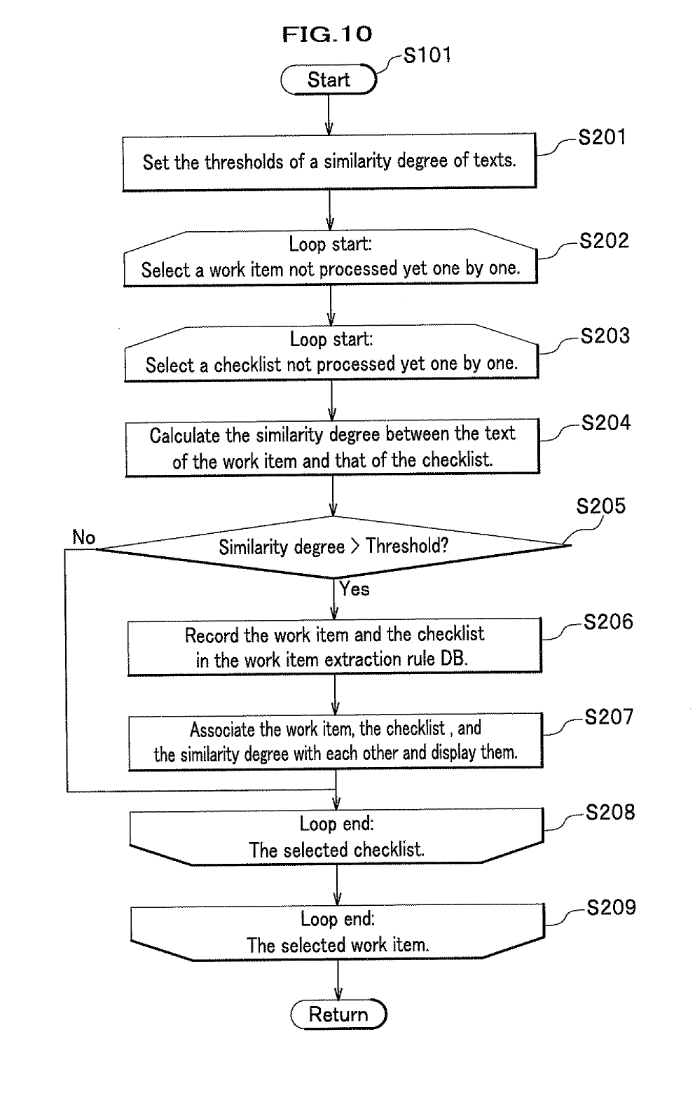

FIG. 10 shows the S101 in detail and is a flowchart showing a process of the corresponding relationship definition unit 8 defining the work item extraction rule DB 3.

The threshold of similarity degrees of texts is set which the threshold is compared when the text information of the checklists recorded in the checklist DB 1 and that of the work items recorded in the work item DB 2 are evaluated whether or not to be similar to each other (S201).

A loop process of selecting a work item not processed yet one by one out of the work items registered in the work item DB 2 is carried out (S202-S209). A loop process of selecting a checklist not processed lists yet one by one out of the checklists registered in the checklist DB 1 is carried out (S203-S208).

By comparing and evaluating the text information included in the selected work item and that included in the selected checklist, the similarity degree of the texts is calculated (S204).

It is determined whether or not the calculated similarity degree is larger than the threshold (S205); when larger (Yes in the S205), the process proceeds to S206; and when not larger (No in the S205), the process proceeds to S208.

The selected work item is associated with the work item code 301, and the selected checklist is associated with the checklist ID 302; the selected work item and the selected checklist are associated with each other and recorded in the work item extraction rule DB 3 (S206). The selected work item, the selected checklist, and the calculated similarity degree are respectively associated with the work item code 901, the checklist ID 902, and the similarity degree 905, and are displayed in the corresponding relationship display unit 9 (S207). Then the two loops are closed.

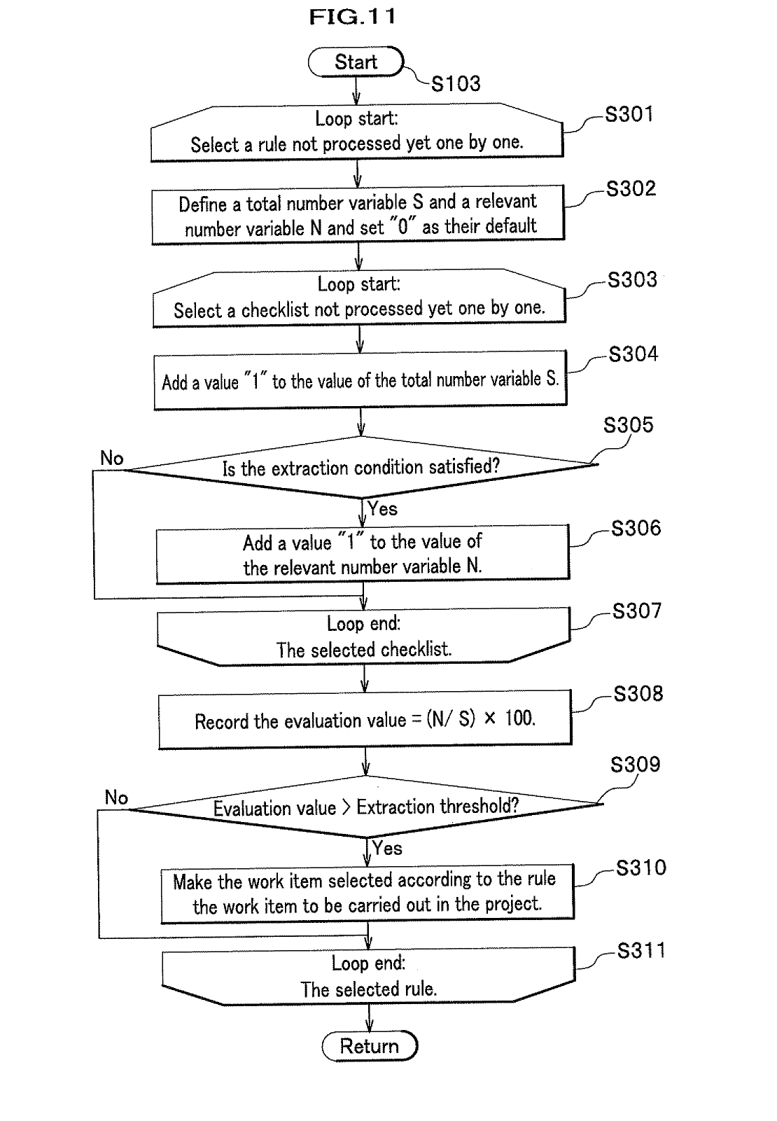

FIG. 11 shows the S103 in detail and is a flowchart showing a process of the work item extraction unit 5 extracting a work item to be carried out in the project.

A loop process of selecting a rule one by one per work item not processed yet from the work item extraction rule DB 3 is carried out (S301-S311). A total number variable S and a relevant number variable N (variable for counting the checklist satisfying the rule) are defined, and “O” is set as their default (S302). A loop process of selecting a checklist one by one per checklist not processed yet specified from the checklist ID 302 of the selected rule is carried out (S303-S307).

A value “1” is added to the value of the total number variable S (S304). Here, it is determined whether or not the input result of the checklist input unit 4 satisfies the extraction condition 303 of the selected checklist (S305); when it satisfies the condition 303 (Yes in the S305), the process proceeds to the S306; and when it does not satisfy the condition 303 (No in the S305), the process proceeds to the S307. A value “1” is added to the value of the relevant number variable N (S306), the loop starting from the S303 is closed (S307).

Then by calculating “{(relevant number variable N/total number variable S)×100 (%)}” as an evaluation value, the value is recorded in the evaluation value 603 (S308). Here, it is determined whether or not the calculated evaluation value 603 is larger than the extraction threshold 304 of the selected rule (S309); when larger (Yes in the S309), the process proceeds to the S310; and when not larger (No in the S309), the process proceeds to the S311. A work item indicated in the work item code 301 of the selected rule is extracted to the work name 602 as a work item to be carried out in the project (S310), and the loop is closed (S311).

According to the embodiment thus described, a rule for associating a checklist and a work item is defined in advance, and the input content of the checklist is checked according to the rule; thereby, the work item in conformity with the rule is extracted. Thus because the work item clearly reflecting the intention of a user who has input the checklist is extracted, it is possible to accurately extract the work item to be carried out in a project.

Because an extracted work item consists of a work item determined by a user to be carried out, and there exists no missing work to be carried out, it is possible to assure the quality of achievements of a project; and because the extracted work item does not include an unnecessary work, a work budget excess due to an excess work may be suppressed, and thus it is possible to enhance the quality of the project.

Furthermore, because checklists input by a user are achievements requested to be separately prepared in a planning stage of a project, it is possible to suppress an additional labor hour of a user inputting data by diverting the input information of the checklists to the extraction process of a work item.

What is claimed is:

1. An apparatus for extracting a work item, the apparatus comprising:
a checklist DB (Data Base) configured to record a checklist that specifies a form of a question and an answer thereto for evaluating a project;
a checklist input unit configured to receive input information to the checklist of the checklist DB;
a work item DB configured to record a candidate group of the work item extracted to be carried out in the project;
a work item extraction rule DB to record the work item, the checklist, and a work item extraction rule that associates an extraction condition with the checklist;
a work item extraction unit, with respect to all the work item of the work item extraction rule DB, configured to determine whether or not the input information of the checklist input unit satisfies the extraction condition of each the checklist corresponding to a predetermined work item, to calculate an evaluation value based on a ratio between a total number of the checklist corresponding to the predetermined work item and a number of the checklist satisfying the extraction condition, and to extract the predetermined work item when the evaluation value exceeds a predetermined threshold; and
a work-item-extraction-result display unit configured to output the work item extracted by the work item extraction unit to a display screen.

2. The apparatus according to claim 1, wherein the work item extraction unit extracts the predetermined work item, and extracts another requested work item to carry out the predetermined work item, based on associated information between the work item recorded in the work item DB.

3. The apparatus according to claim 1, wherein when the work item extraction unit extracts the predetermined work item, the work item extraction unit refers to a kind of the checklist recorded in the checklist DB, focuses on a checklist whose kind is a risk, and determines whether or not the input information of the checklist input unit satisfies an extraction condition of the focused checklist, and
wherein the work-item-extraction-result display unit outputs the evaluation value calculated by the work item extraction unit as a certainty of the project.

4. The apparatus according to claim 2, wherein when the work item extraction unit extracts the predetermined work item, the work item extraction unit refers to a kind of the checklist recorded in the checklist DB, focuses on a checklist whose kind is a risk, and determines whether or not the input information of the checklist input unit satisfies an extraction condition of the focused checklist, and
wherein the work-item-extraction-result display unit outputs the evaluation value calculated by the work item extraction unit as a certainty of the project.

5. The apparatus according to claim 1, wherein when the work item extraction unit extracts the predetermined work item, the work item extraction unit refers to a kind of the checklist recorded in the checklist DB, focuses on a checklist whose kind is a merit, and determines whether or not the input information of the checklist input unit satisfies an extraction condition of the focused checklist, and
wherein the work-item-extraction-result display unit outputs the evaluation value calculated by the work item extraction unit as a priority of the project.

6. The apparatus according to claim 2, wherein when the work item extraction unit extracts the predetermined work item, the work item extraction unit refers to a kind of the checklist recorded in the checklist DB, focuses on a checklist whose kind is a merit, and determines whether or not the input information of the checklist input unit satisfies an extraction condition of the focused checklist, and
wherein the work-item-extraction-result display unit outputs the evaluation value calculated by the work item extraction unit as a priority of the project.

7. The apparatus according to claim 1, wherein the work-item-extraction-result display unit changes and displays a display color of the extracted work item, depending on the evaluation value calculated by the work item extraction unit.

8. The apparatus according to claim 2, wherein the work-item-extraction-result display unit changes and displays a display color of the extracted work item, depending on the evaluation value calculated by the work item extraction unit.

9. The apparatus according to claim 3, wherein the work-item-extraction-result display unit changes and displays a display color of the extracted work item, depending on the evaluation value calculated by the work item extraction unit.

10. The apparatus according to claim 4, wherein the work-item-extraction-result display unit changes and displays a display color of the extracted work item, depending on the evaluation value calculated by the work item extraction unit.

11. The apparatus according to claim 5, wherein the work-item-extraction-result display unit changes and displays a display color of the extracted work item, depending on the evaluation value calculated by the work item extraction unit.

12. The apparatus according to claim 6, wherein the work-item-extraction-result display unit changes and displays a display color of the extracted work item, depending on the evaluation value calculated by the work item extraction unit.

13. The apparatus according to claim 1, wherein the work-item-extraction-result display unit changes and displays a display pattern of the extracted work item, depending on the evaluation value calculated by the work item extraction unit.

14. The apparatus according to claim 2, wherein the work-item-extraction-result display unit changes and displays a display pattern of the extracted work item, depending on the evaluation value calculated by the work item extraction unit.

15. The apparatus according to claim 3, wherein the work-item-extraction-result display unit changes and displays a display pattern of the extracted work item, depending on the evaluation value calculated by the work item extraction unit.

16. The apparatus according to claim 1 further comprising:
a corresponding relationship definition unit configured to associate the checklist of the checklist DB and the work item of the work item DB, which the checklist and the work item are used in calculating a similarity degree of a text included in the checklist and a text included in the work item, and to record the checklist and the work item in the work item extraction rule DB when the similarity degree of the texts exceeds a predetermined threshold,
wherein the apparatus compares the texts, and calculates the similarity degree between the texts.

17. The apparatus according to claim 2 further comprising:
a corresponding relationship definition unit configured to associate the checklist of the checklist DB and the work item of the work item DB, which the checklist and the work item are used in calculating a similarity degree of a text included in the checklist and a text included in the work item, and to record the checklist and the work item in the work item extraction rule DB when the similarity degree of the texts exceeds a predetermined threshold,
wherein the apparatus compares the texts, and calculates the similarity degree between the texts.

18. The apparatus according to claim 16 further comprising a corresponding relationship display unit configured to associate and display the work item, the checklist, and the similarity degree between both of the texts calculated by the corresponding relationship definition unit.

19. A method for extracting a work item in an apparatus for the same having a checklist DB; a checklist input unit; a work item DB; a work item extraction rule DB; a work item extraction unit; and a work-item-extraction-result display unit, the method comprising the steps of:
recording in the checklist DB a checklist that specifies a form of a question and an answer thereto for evaluating a project;
receiving input information to the checklist of the checklist DB;
recording in the work item DB a candidate group of the work item extracted to be carried out in the project;
recording in the work item extraction rule DB the work item, the checklist, and a work item extraction rule that associates an extraction condition with the checklist;
with respect to all the work item of the work item extraction rule DB, making the work item extraction unit determine whether or not the received input information satisfies the extraction condition of each the checklist corresponding to a predetermined work item, calculate an evaluation value based on a ratio between a total number of the checklist corresponding to the predetermined work item and a number of the checklist satisfying the extraction condition, and extract the predetermined work item when the evaluation value exceeds a predetermined threshold; and
making the work-item-extraction-result display unit output the work item extracted by the work item extraction unit to a display screen.

20. A computer readable program for extracting a work item in an apparatus for the same having a checklist DB; a work item DB; a work item extraction rule DB; a work item extraction unit; and a work-item-extraction-result display unit, the program comprising the steps of:
recording in the checklist DB a checklist that specifies a form of a question and an answer thereto for evaluating a project;
receiving input information to the checklist;
recording in the work item DB a candidate group of the work item extracted to be carried out in the project;
recording in the work item extraction rule DB the work item, the checklist, and a work item extraction rule that associates an extraction condition with the checklist;
with respect to all the work item of the work item extraction rule DB, making the work item extraction unit determine whether or not the received input information satisfies the extraction condition of each the checklist corresponding to a predetermined work item, calculate an evaluation value based on a ratio between a total number of the checklist corresponding to the predetermined work item and a number of the checklist satisfying the extraction condition, and extract the predetermined work item when the evaluation value exceeds a predetermined threshold; and
making the work-item-extraction-result display unit outputting the work item extracted by the work item extraction unit to a display screen.
